(19) United States
(12) Patent Application Publication
(10) Pub. No.: US 2025/0261616 A1
(43) Pub. Date: Aug. 21, 2025

(54) PET HARNESS WITH MAGNETIC CHAIN ATTACHMENT

(71) Applicant: Clayton Munoz, Rancho Palos Verdes, CA (US)

(72) Inventor: Clayton Munoz, Rancho Palos Verdes, CA (US)

(21) Appl. No.: 18/582,484

(22) Filed: Feb. 20, 2024

(51) Int. Cl. A01K 27/00

(52) U.S. Cl. CPC A01K 27/002

(57) ABSTRACT

A harness for a canine for use with a metal leash or chain includes a planar magnet that can be used to store the metal leash or chain when not in use.

### BACKGROUND

### Summary of the Invention

Dog harnesses are an essential tool for pet owners who want to ensure the safety and comfort of their canine companions during walks and other outdoor activities. Unlike traditional collars, harnesses distribute the force of leash pulling across a dog's chest and back, reducing the risk of neck strain and injury. With a variety of styles and designs available, harnesses can accommodate dogs of all shapes and sizes, providing a secure and snug fit that prevents slipping or escape. Additionally, some harnesses feature padding and reflective elements for added visibility during low-light conditions, enhancing both safety and style.

When it comes to the interaction between dog harnesses and leashes, the design of the harness plays a crucial role in controlling and guiding the dog's movements. The leash attachment point on a harness is strategically positioned to offer better control over the dog's direction and pace. Front-clip harnesses, for example, discourage pulling by redirecting the dog's forward motion towards the owner, promoting better leash manners. Meanwhile, back-clip harnesses provide a more relaxed walking experience, ideal for well-behaved dogs who don't pull excessively. By attaching the leash to the appropriate point on the harness, pet owners can effectively communicate with their dogs and reinforce positive walking behaviors.

For large dogs, many owners prefer a chain to a leather leash or strap. Chains offer greater strength and flexibility when compared with certain leather leashes. The present invention takes advantage of the metallic attributes of chain/harness combinations by providing a convenient location to attach the chain to the harness for quick and easy access and storage.

### BRIEF DESCRIPTION OF THE DRAWINGS

FIG. 1 is a perspective view of a first embodiment of the present invention;

FIG. 2 is a perspective view of the chain attached to the harness;

FIG. 3 is a plan view of the harness;

FIG. 4 is an elevated perspective exploded view of the harness;

FIG. 5 is a perspective view of an alternate embodiment of the present invention; and

FIG. 6 is a perspective view of the chain attached to the collar of FIG. 5

### DETAILED DESCRIPTION OF THE PREFERRED EMBODIMENTS

Dog harnesses and chains work together to promote a harmonious and enjoyable walking experience for both pets and their owners. When properly fitted and used, harnesses offer a secure and comfortable way to control a dog's movement without causing discomfort or strain. By understanding the dynamics of harness and chain interactions, pet owners can select the most suitable equipment for their dogs and foster positive walking habits, leading to safer and more pleasant outings for everyone involved.

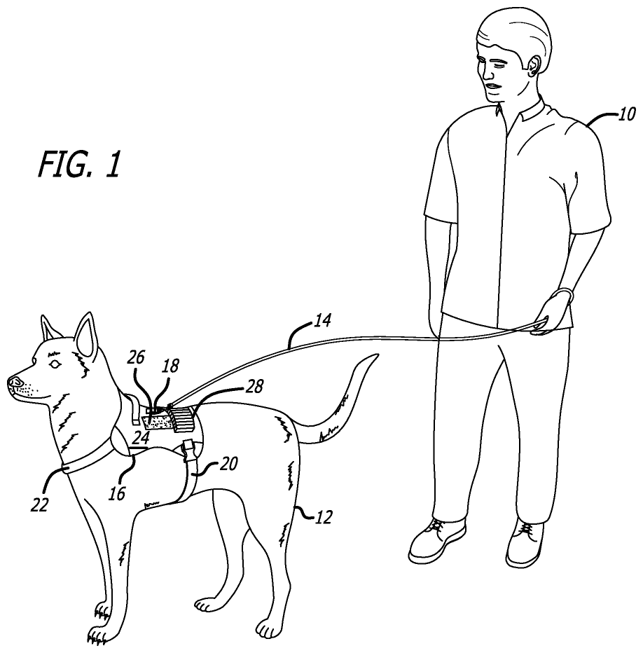

FIG. 1 illustrates a first embodiment of the present invention showing a user 10 and his canine 12. The canine 12 is tethered with a chain 14 that attaches to a harness 16. The use of harnesses to better distribute the loads applied by the restraint is preferred over collars in some situations. Here, the chain 14 attaches to the harness 16 using a clip 18 that attaches and disconnects from the chain 14 as needed, typically using a release button (not shown). The harness 16 includes a strap 20 that passes around the torso of the animal and a second strap 22 that encircles the dog's neck as shown. The harness 16 also includes on an outer surface 24 a pair of patches 26 sewn onto the surface of the harness 16, such as hook and loop (e.g., Velcro®) fastener patch. The patches 26 serve to secure a planar magnet 28 on each side of the harness 16, where the magnet has a width and/or a length that is at least four times its depth. In a preferred embodiment, two magnets 28 are provided, one on each patch 26.

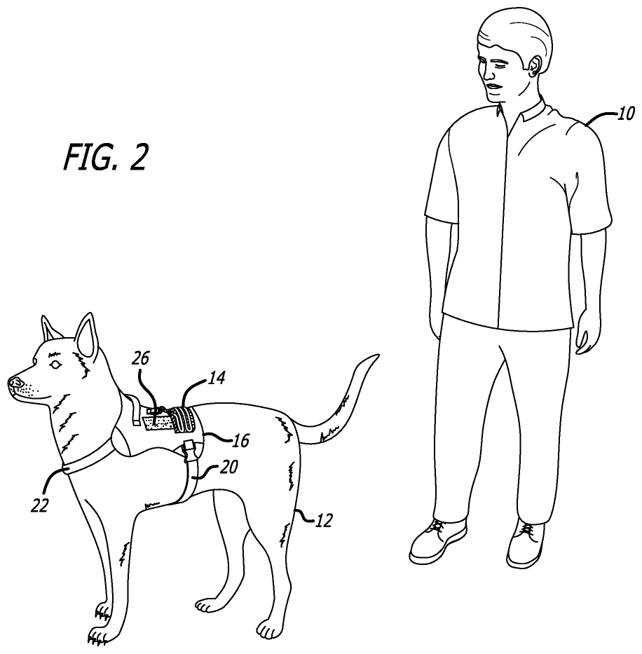

FIG. 2 illustrates the purpose of the magnet(s) 28, namely to secure the chain 14 when not in use. The user 10 may fold up the chain and use its magnetic properties to attach the chain to the harness 16 when not in use. This provides a convenient location where the chain and harness do not ever have to be separated and lost, as the chain is always with the harness.

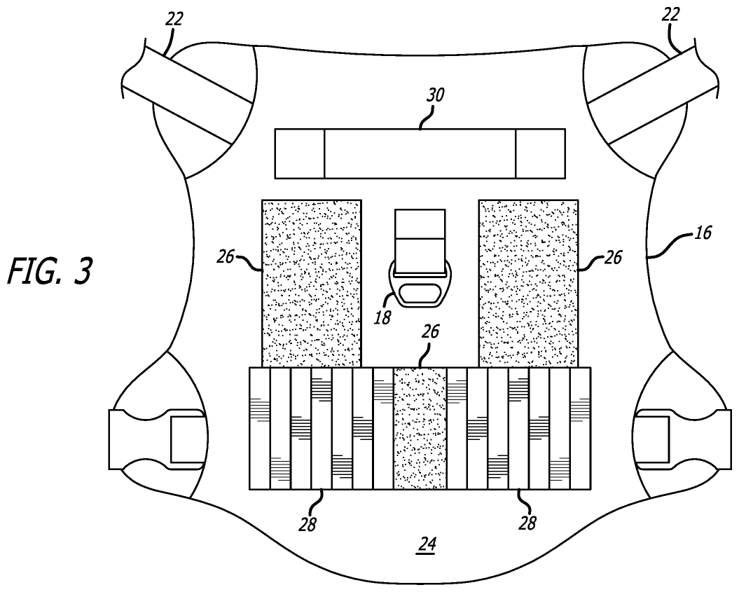

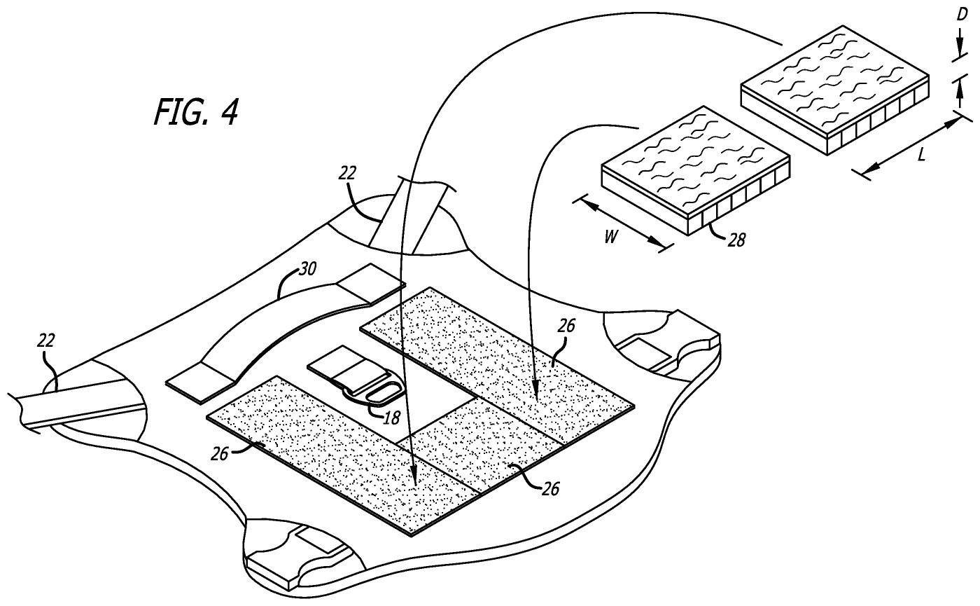

FIG. 3 is a plan view of the harness 16 laid flat. Hook and loop patches 26 secure the planar magnets 28 to the outer surface 24 of the harness so that the chain 14 can be attached. The harness 16 can include a handle 30 that can be used to restrain the animal when use of the chain is not optimal. In FIG. 4, the magnets 28 are shown off of the hook and loop patches 26. Complimentary material is affixed to the bottom surface of the planar magnets to provide for the attachment of the magnets to the patches. The planar magnets have a length L, a width W, and a depth D, where in preferred embodiment

L>4D and/or W>4D;

i.e., the length and/or width is greater than four times the depth of the magnet. The surface area of the magnet (or magnets) is preferably greater than fifty percent of the combined surface area of the chain, and more preferably the surface area of the magnet (or magnets) is greater than seventy-five percent of the combined surface area of the chain. In yet another preferred embodiment, the entire chain may fit within the surface area of the magnet.

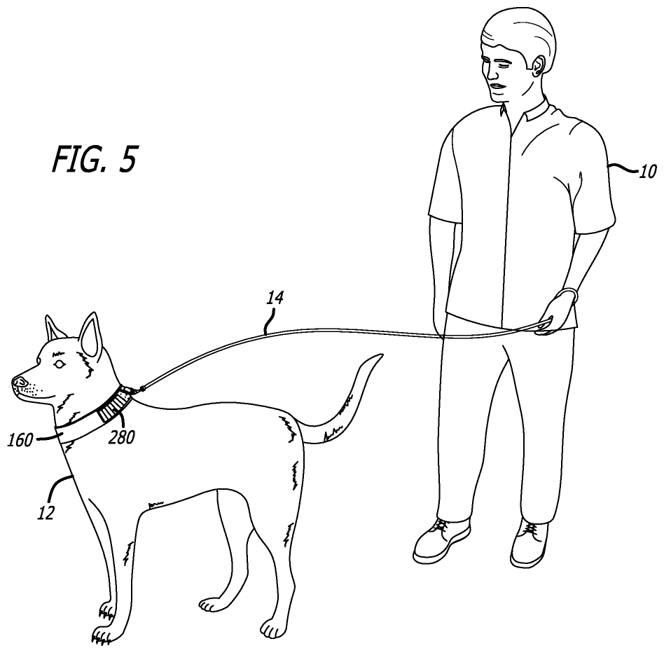

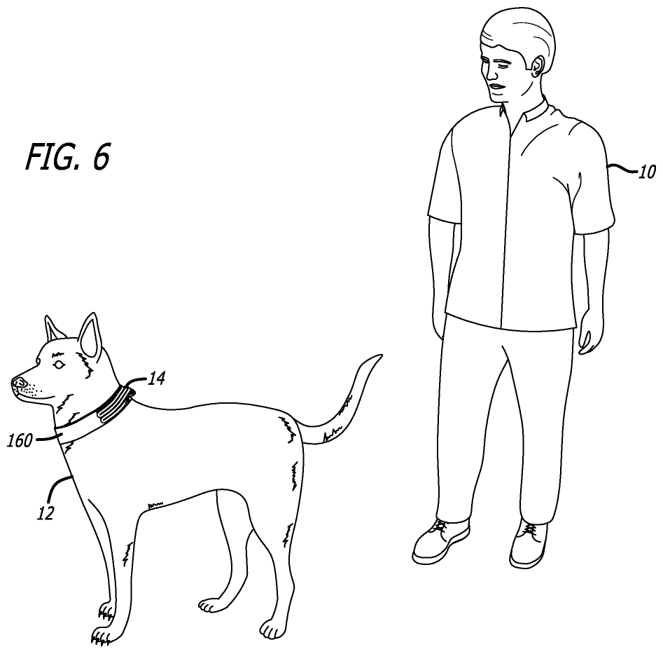

FIGS. 5 and 6 illustrate an alternate embodiment comprising a collar 160 in place of the harness 16. The collar 160 includes a planar magnet 280 on the collar 160 that can be used to attach the chain 14 to the collar.

While various embodiments have been described and depicted in the drawings, it is understood that the invention is not limited to only those embodiments depicted. A person of ordinary skill in the art would readily recognize and appreciate various substitutions, modifications, and alterations to the depicted embodiments, and the invention's scope is intended to include all such changes. Accordingly, the invention's scope is properly measured by the appended claims using their plain and ordinary meanings, consistent with but not limited by the foregoing descriptions.

I claim:

1. A restraint system for a canine, comprising:
a chain; and
a harness, the harness including a clip for attaching an end of the chain thereto, and a having at least one magnet for attaching the chain to the harness when not in use, the at least one magnet having a surface area;
wherein the surface area of the planar magnet is sufficient to cover at least a majority of a surface area of the chain.

2. The restraint system for a canine of claim 1, wherein the harness includes patches of hook and loop material used to attach the planar magnet to an outer surface of the harness.

3. The restraint system for a canine of claim 1, wherein the surface area of the magnet is sufficient to cover the surface area of the chain.
